(19) United States
(12) Patent Application Publication
(10) Pub. No.: US 2020/0194785 A1
(43) Pub. Date: Jun. 18, 2020

(54) NEGATIVE ACTIVE MATERIAL, LITHIUM SECONDARY BATTERY INCLUDING THE NEGATIVE ACTIVE MATERIAL, AND METHOD OF PREPARING THE NEGATIVE ACTIVE MATERIAL

(71) Applicants: Samsung Electronics Co., Ltd., Suwon-si (KR); Samsung SDI Co., Ltd., Yongin-si (KR)

(72) Inventors: Heechul JUNG, Seoul (KR); Jeeeun YANG, Uiwang-si (KR); Jongseok MOON, Suwon-si (KR); Seunguk KWON, Suwon-si (KR); Seongho JEON, Yongin-si (KR); Sungsoo HAN, Hwaseong-si (KR)

(21) Appl. No.: 16/711,547

(22) Filed: Dec. 12, 2019

(30) Foreign Application Priority Data
Dec. 13, 2018 (KR) 10-2018-0161187

(51) Int. Cl. H01M 4/36; H01M 4/485; H01M 4/62; H01M 4/38; H01M 4/48; H01M 10/0525

(52) U.S. Cl. CPC H01M 4/366; H01M 4/485; H01M 4/625; H01M 2004/027; H01M 4/483; H01M 10/0525; H01M 4/386

(57) ABSTRACT

A negative active material includes: an active material core; and a composite coating layer located on a surface of the active material core, wherein the composite coating layer includes a lithium-containing oxide having an orthorhombic crystal structure, and a first carbonaceous material, the lithium-containing oxide.

### CROSS-REFERENCE TO RELATED APPLICATION

This application claims priority to and the benefit of Korean Patent Application No. 10-2018-0161187, filed on Dec. 13, 2018, in the Korean Intellectual Property Office, and all the benefits accruing therefrom under 35 U.S.C. § 119, the content of which is incorporated herein by reference in its entirety.

### BACKGROUND

### 1. Field

The present disclosure relates to a negative active material, a lithium secondary battery employing the same, and a method of preparing the negative active material.

### 2. Description of the Related Art

Lithium ion batteries (LIBs) have been used for decades as a power source for mobile electronic devices due to their high energy density and simplicity of design. In the future, it is anticipated that the use of LIBs may be expanded to power storage devices for use in electric vehicles and renewable energy. In order to meet market demands, extensive research has been conducted into identifying LIB materials having higher energy density and longer lifespan characteristics. For example, materials which may be used as double layer negative electrode materials have been studied.

From among these double layer negative electrode materials, silicon-based materials are receiving attention since they have about 10 fold greater energy density per weight and about 2 to 3 times greater energy density per volume as compared to graphite which is currently commercialized. However, with a silicon-based negative electrode material, an unstable solid-electrolyte interphase (SEI) layer may be formed due to a side reaction between a silicon surface and an electrolyte, thereby deteriorating the electrochemical characteristics. Additionally, internal stress may caused by rapid volume expansion, which occurs during battery charge and discharge, resulting in crushing of the electrode materials.

Therefore, there remains a need to develop a high-capacity negative active material, such as a silicon active material, which improves the lifespan characteristics and rate characteristics of a lithium battery.

### SUMMARY

Provided is a negative active material in which cracking is prevented and side reactions on surfaces thereof are reduced, thereby improving the lifespan characteristics of a lithium secondary battery.

Provided is a lithium secondary battery including the negative active materials.

Provided also is a method of preparing the negative active material.

Additional aspects will be set forth in part in the description which follows and, in part, will be apparent from the description, or may be learned by practice of the presented embodiments.

According to an aspect of an embodiment, a negative active material includes: an active material core; and a composite coating layer on a surface of the active material core, wherein the composite coating layer includes a lithium-containing oxide and a first carbonaceous material, the lithium-containing oxide having an orthorhombic crystal structure.

According to another aspect of an embodiment, a lithium secondary battery includes a negative electrode including the negative active material, a cathode, and an electrolyte between the negative electrode and the positive electrode.

According to another aspect of an embodiment, a method of manufacturing a negative active material includes: providing a dry mixture including an active material core and a coating precursor, wherein the coating precursor includes a lithium precursor and a carbon precursor, and the lithium precursor is lithium oxide (Li₂O); and heat-treating the dry mixture to form a composite coating layer on a surface of the active material core, wherein the composite coating layer includes a lithium-containing oxide and a first carbonaceous material, and the lithium-containing oxide has an orthorhombic crystal structure.

Also disclosed is a negative active material including: an active material core including a porous silicon-containing secondary particle; and a composite coating layer on a surface of the active material core, wherein the composite coating layer includes a lithium silicon oxide having an orthorhombic crystal structure, and a first carbonaceous material.

### BRIEF DESCRIPTION OF THE DRAWINGS

These and/or other aspects will become apparent and more readily appreciated from the following description of the embodiments, taken in conjunction with the accompanying drawings in which:

FIG. 1 is a schematic diagram illustrating an embodiment of the structure of a negative active material;

FIG. 2 is an illustration comparing an orthorhombic crystal structure and a monoclinic crystal structure;

FIG. 3 is a graph of intensity (arbitrary units, a.u.) versus diffraction angle (degrees 2-theta, 2θ), which shows the results of X-ray diffraction (XRD) analysis for the negative active material prepared in Example 1;

FIG. 4 is a graph of intensity (arbitrary units, a.u.) versus diffraction angle (degrees 2θ), which shows the results of XRD analysis for the negative active material prepared in Comparative Example 1;

FIG. 5 is a graph of absorbance (a.u.) versus wavenumber (cm⁻¹), which shows the results of Fourier transform infrared (FT-IR) analysis of the negative active materials prepared according to Example 1 and Comparative Example 1;

FIGS. 6A to 6C are scanning electron microscope (SEM) images of the negative active material prepared according to Comparative Example 1;

FIGS. 7A to 7C are SEM images of the negative active material prepared according to Example 1;

FIG. 8A is an SEM image of the negative active material prepared according to Example 1;

FIGS. 8B to 8D are element mapping results corresponding to the SEM image in FIG. 8A;

FIG. 9A is a transmission electron microscope (TEM) image of a cross-section of the negative active material prepared according to Example 1;

FIGS. 9B to 9D are element mapping results corresponding to the indicated portion of the TEM image in FIG. 9A;

FIG. 10 is a graph of cycle retention (percent, %) versus cycle number (No.), which shows the results obtained by measuring the capacity retention of the coin half cells manufactured according to Example 1 and Comparative Example 1;

FIG. 11 is a graph of coulombic efficiency (%) versus cycle number (No.), which shows the results obtained by measuring the coulombic efficiency of the coin half cells manufactured according to Example 1 and Comparative Example 1;

FIG. 12 is a graph of cycle retention (%) versus cycle number (No.), which shows the results obtained by measuring the capacity retention of the coin full cells manufactured according to Example 1 and Comparative Example 1;

FIG. 13 is a graph of coulombic efficiency (%) versus cycle number (No.), which shows the results obtained by measuring the coulombic efficiency of the coin full cells manufactured according to Example 1 and Comparative Example 1;

FIG. 14 is a graph of cycle retention (%) versus cycle number (No.), which shows the results obtained by measuring the capacity retention of a mini circular cell using each of the negative active materials of Example 1 and Comparative Examples 1 and 2;

FIG. 15 is a graph of internal resistance (ohms, Ω) versus cycle number (No.), which shows the results obtained by measuring the internal resistance of the coin half cells manufactured according to Example 1 and Comparative Example 1;

FIG. 16 is a graph of internal resistance (ohms, Ω) versus cycle number (No.), which shows the results obtained by measuring the internal resistance of the coin full cells manufactured according to Example 1 and Comparative Example 1;

FIG. 17 is a histogram illustrating charge capacity ratio (percent), determined according to Equation 4, which compares the constant current charge capacity to the constant current-constant voltage charge capacity, after formation at a 0.1 C rate or a 0.2 C rate, and after 50 and 100 cycles at a 0.2 C rate for the coin half cells manufactured according to Example 1 and Comparative Example 1;

FIG. 18 is a graph of capacity retention (%) versus cycle number (No.), which shows the results obtained by measuring the capacity retention of the coin full cells manufactured in Example 1 and Comparative Examples 3 and 4;

FIG. 19 is a graph of coulombic efficiency (%) versus cycle number (No.), which shows the results obtained by measuring the coulombic efficiency of the coin full cells manufactured according to Example 1 and Comparative Examples 3 and 4;

FIG. 20 is a histogram illustrating capacity retention (%) versus cycle number (No.), which shows the charge capacity of the coin full cells manufactured according to Example 1 and Comparative Examples 3 and 4 after formation and after 100 cycles using 0.2 C constant current charging and discharging;

FIG. 21 is a graph of capacity retention (%) versus the number of charge/discharge cycles, which shows the charge capacity of the coin full cells manufactured according to Example 1 and Comparative Examples 3 and 4 after the coin full cells were charged and discharged 1, 10, 20, 30, 40, 50, 60, 70, 80, 90, and 100 times using 1C constant current charging and discharging;

FIG. 22 is a graph of intensity (a.u.) versus diffraction angle (degrees 2θ), which shows the results of XRD analysis of the crystal structure of the coating layer of the negative active materials manufactured according to Example 1 and Comparative Examples 3 and 4;

FIG. 23 is a graph of counts (a.u.) versus binding energy, comparing the X-ray photoelectron spectroscopy (XPS) measurements of negative active materials of Comparative Example 1 and Example 1 after charging and discharging; and

FIG. 24 is a cross-sectional schematic view of the structure of a lithium secondary battery according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third,” etc. may be used herein to describe various elements, components, regions, layers and/or sections, these elements, components, regions, layers, and/or sections should not be limited by these terms. These terms are only used to distinguish one element, component, region, layer or section from another element, component, region, layer, or section. Thus, “a first element,” “component,” “region,” “layer,” or “section” discussed below could be termed a second element, component, region, layer or section without departing from the teachings herein.

The terminology used herein is for the purpose of describing particular embodiments only and is not intended to be limiting. As used herein, “a,” “an,” “the,” and “at least one” do not denote a limitation of quantity, and are intended to cover both the singular and plural, unless the context clearly indicates otherwise. For example, “an element” has the same meaning as “at least one element,” unless the context clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Silicon-based materials have been evaluated as a potential double layer negative electrode material due to their high energy density. However, an unstable solid-electrolyte interphase (SEI) layer may be formed due to a side reaction between a silicon surface of the silicon-based material and an electrolyte, thereby deteriorating the electrochemical characteristics of the battery. In addition, internal stress may be caused by a rapid volume expansion occurring during battery charge and discharge, resulting in the crushing of the electrode material.

To prevent the deterioration of electrochemical characteristics and crushing of electrode materials, extensive research has been conducted to improve the reversibility at the surface of the active material, for example, by applying a surface treatment on the active material. For example, a lithium oxide and/or a carbon material capable of conducting both lithium ions and electrons have been studies as a way to improve lithium-ion conductivity. Further, carbon materials are widely used as surface-coating materials and composite materials in commercial products.

However, although carbon materials conduct both lithium ions and electrons and are most widely used as composite and coating materials, their fracture strength and flexibility are not enough to endure the stress caused by the expansion of silicon active materials. As a result, and while not wanting to be bound by theory, it is understood that when active materials expand, the coated carbon layer cracks to form a new SEI on the fracture surface of the carbon coating layer as well as on silicon, or when a coating or composite is formed such that the crystallinity of carbon is decreased, irreversible Li-containing materials may be formed on a prismatic plane, leading to a decrease in the amount of reversible lithium in a battery.

Lithium-containing oxides may improve the conductivity and initial reversibility of lithium ions. However, they are not effective in providing long lifespan characteristics due to the stress caused by repeatedly occurring volumetric changes during charging and discharging. In addition, since oxides have low electronic conductivity, when they are excessively coated, reactivity with lithium may be decreased and reversible capacity may be decreased.

Charged and discharge rates are described herein using C rates. A C rate is a discharge rate of a cell, and is obtained by dividing a total capacity of the cell by a total discharge period of time, e.g., a C rate for a battery having a discharge capacity of 1.6 ampere-hours would be 1.6 amperes.

Hereinafter, a negative active material according to an embodiment, a lithium secondary battery using the same, and a method of preparing the negative active material will be described in further detail.

A negative active material comprises

an active material core; and

a composite coating layer on the surface of the active material core,

wherein the composite coating layer includes a lithium-containing oxide having an orthorhombic crystal structure, and a first carbonaceous material.

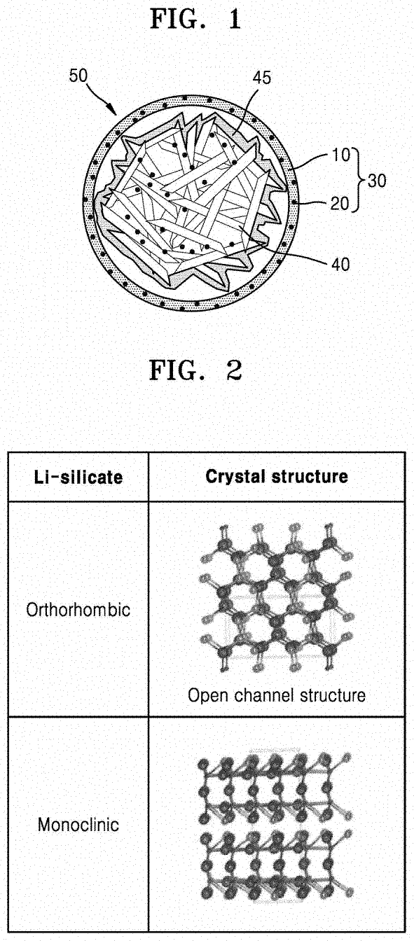

FIG. 1 shows a schematic diagram illustrating the structure of a negative active material according to an embodiment.

As shown in FIG. 1, in the negative active material 50, the surface 45 of the active material core 40 is co-surface treated with a carbonaceous material 10, which is used to improve electronic conductivity and structural stability, and a lithium-containing oxide 20, which is used to improve the conductivity of lithium ions. The carbonaceous material and the lithium-containing oxide are used in a composite form to provide a composite coating layer 30 on the active material core 40.

In the composite coating layer 30, the lithium-containing oxide 20 is dispersed in the first carbonaceous material 10 which acts as a matrix. When the active material core 40 has a porous structure, the composite coating layer 30 may be formed on the surface of the active material core 40 and inside of the active material core 40 (e.g., inside a pore of the active material core 40).

Due to the inclusion of the composite coating layer 30, the negative active material 50 may improve the lifespan characteristics of the lithium secondary battery by reducing the irreversible lithium consumption reaction at the interface thereof with an electrolyte. In addition, due to the dynamic limitations of the surface, the conductivity of lithium ions at the surface of the negative active material may be improved and may reduce the number of lithium ions which do not escape from the negative active material and are trapped therein during charge and discharge.

In a negative active material according to an embodiment, a composite coating layer, including a lithium-containing oxide having an orthorhombic crystal structure and a first carbonaceous material, is disposed on the surface of an active material core.

The orthorhombic crystal structure is compared to a monoclinic crystal structure in FIG. 2. As shown in FIG. 2, an orthorhombic crystal structure is structurally more open than a monoclinic crystal structure, and as a result, there is an increase in the conductivity of lithium ions at the surface of a negative active material. Accordingly, the amount of lithium ions which do not escape from the negative active material and are trapped therein during charge and discharge due to the dynamic limitations of the surface, and which leads to a decrease in the entire cell capacity, may be reduced.

The lithium-containing oxide having the orthorhombic crystal structure may be represented by Formula 1 below.

LiₓM_{y}O_{z} Formula 1

wherein

M comprises Si, Al, Ti, Mn, Ni, Cu, V, Zr, Nb, or a combination thereof; and

0<x≤8, 0<y≤3 and 0<z≤(x+m·y)/2, where m is the oxidation number of M.

In an embodiment, the lithium-containing oxide may comprise LiₓSi_{y}Oz, LiₓAl_{y}O_{z}, LiₓTi_{y}O_{z}, LiₓZr_{y}O_{z}, or a combination thereof, each having an orthorhombic crystal structure, where x, y, and z are the same as defined in Formula 1. For example, the lithium-containing oxide may include Li₂SiO₃ having an orthorhombic crystal structure.

The term “carbonaceous” as it pertains to the first carbonaceous material, refers to a material composed of at least about 50 weight percent (wt %) of carbon. For example, the first carbonaceous material may include at least about 60 wt %, about 70 wt %, about 80 wt %, or about 90 wt % carbon, or about 100 wt % carbon, e.g., about 50 wt % to 100 wt %, or about 60 wt % to about 90 wt % carbon, based on a total weight of the carbonaceous material. The first carbonaceous material may include a crystalline carbon, an amorphous carbon, or a combination thereof.

Examples of the crystalline carbon include natural graphite, artificial graphite, expandable graphite, graphene, carbon black, fullerene soot, or a combination thereof, and are not limited thereto. Natural graphite refers to naturally occurring graphite, and examples thereof include flake graphite, high crystalline graphite, microcrystalline or cryptocrystalline (amorphous) graphite, or a combination thereof, but is not limited thereto. Artificial graphite refers to artificially synthesized graphite, made by heating amorphous carbon to a high temperature, and examples thereof include primary graphite (electrographite), secondary graphite, graphite fiber, or a combination thereof, but is not limited thereto. Expandable graphite is obtained by the intercalation of a chemical, such as acid or alkali, between layers of graphite, and heating the chemical to inflate the vertical layer of the graphite molecular structure. Graphene contains a single layer of graphite or a plurality of single layers of graphite. Carbon black is a crystalline material having less structural regularity than graphite and may be converted to graphite by heating at a temperature of about 3,000° C. for a prolonged period of time. Fullerene soot is a carbon mixture containing at least 3 wt % fullerene, which is a polyhedral structure consisting of about 60 or more carbon atoms. For use as the first carbonaceous material, the above-described crystalline carbon materials may be used alone or as a combination of two or more. For example, natural graphite, artificial graphite, or a combination thereof may be used. The crystalline carbon may have a spherical, tabular, fibrous, tubular, and/or powder form.

Examples of the amorphous carbon include soft carbon, hard carbon, pitch carbide, mesophase pitch carbide, calcined coke, polymer carbide, or a combination thereof. The amorphous carbon may be formed by carbonizing, for example, a carbon precursor such as coal pitch, mesophase pitch, petroleum pitch, coal oil, petroleum heavy oil, or organic synthesis pitch, or a polymer resin such as a phenol resin, a furan resin, a polyimide resin, or a combination thereof. The carbonization occurs by applying a heat treatment to the amorphous carbon. The heat treatment temperature for the carbonization may be in the range of about 500° C. to about 1400° C. In an embodiment, the heat treatment may be performed at the temperature of about 500° C. to about 950° C. in the aspect of lowering the crystallization degree of C.

When a combination of crystalline carbon and amorphous carbon is used as the first carbonaceous material, the crystalline carbon may be combined with a carbon precursor, such as coal pitch, mesophase pitch, petroleum pitch, coal oil, petroleum heavy oil, and/or organic synthesis pitch, or a polymer resin such as a phenol resin, a furan resin, and/or a polyimide resin to prepare a mixture, followed by carbonizing the mixture using a heat treatment to obtain amorphous carbon as the first carbonaceous material.

In the composite coating layer, the lithium-containing oxide having the orthorhombic crystal structure may be dispersed in the first carbonaceous material which is used as a matrix. The composite coating layer including the lithium-containing oxide having the orthorhombic crystal structure, which is formed during the carbonizing heat treatment, may diffuse into the active material core, thereby being dispersed inside the active material core. Accordingly, the composite coating layer may disposed on the surface of the active material core and inside of the active material core.

In an embodiment, the composite coating layer may further include a crystalline silicon oxide. The crystalline silicon oxide may be formed by diffusion of the silicon component contained in the active material core into the composite coating layer during the heat treatment process.

The weight ratio of the lithium-containing oxide to the first carbonaceous material in the composite coating layer may range from 1:99 to 99:1. In an embodiment, the weight ratio of the lithium-containing oxide to the first carbonaceous material in the composite coating layer may range from about 10:90 to about 90:10. In an embodiment, the weight ratio of the lithium-containing oxide to the first carbonaceous material in the composite coating layer may range from about 20:80 to about 80:20. In an embodiment, the weight ratio of the lithium-containing oxide to the first carbonaceous material in the composite coating layer may range from about 25:75 to about 75:25. Within these ranges, a composite coating layer that improves not only the electronic conductivity and structural stability of the negative active material, but also the lithium-ion conductivity thereof, may be formed.

The amount of the composite coating layer may be in the range of about 0.01 part by weight to about 10 parts by weight, based on 100 parts by weight of the active material core. In an embodiment, the amount of the composite coating layer may be in the range of about 0.1 part by weight to about 7 parts by weight, based on 100 parts by weight of the active material core. In an embodiment, the amount of the composite coating layer may be in the range of about 1 part by weight to about 5 parts by weight, based on 100 parts by weight of the active material core. Within these ranges, the effects of improving the structural stability of the active material core and suppressing the side reaction at the surface of the negative active material may be effectively obtained.

The thickness of the composite coating layer may be uniform or non-uniform depending on the amount of a coating material used. The thickness of the composite coating layer may be in the range of, for example, about 0.1 nanometers (nm) to about 50 nm, about 0.5 nm to about 30 nm, or about 1 nm to about 20 nm.

The composite coating layer may be coated on the entire surface of the active material core or on a portion thereof. For example, the composite coating layer may be coated on at least 75%, or at least 80%, or at least 90%, or at least 95% of the total surface of the active material core, or about 50% to 100%, or about 60% to about 90%, of the total surface of the active material core. In an embodiment, the composite coating layer may be coated on 100% of the total surface of the active material core. When the active material core has a porous structure, the composite coating layer may be disposed inside the porous structure of the active material core. The method of coating the composite coating layer on the active material core is not limited. In an embodiment, a dry coating method may be used. As an example of the dry coating, vapor deposition, chemical vapor deposition (CVD), or the like may be used. However, the dry coating method is not limited thereto and may be any suitable dry coating method.

The composite coating layer improves the structural stability of the active material core, and reduces the irreversible lithium consumption reaction at the interface of an active material with an electrolyte, to improve the lifespan characteristics of the lithium battery.

The active material core used for a negative active material, according to an embodiment, may include any material that is capable of intercalating and deintercalating lithium and which demonstrates high capacity as a negative active material in a lithium battery.

In an embodiment, the active material core may include a silicon-based active material, a tin-based active material, a silicon-tin alloy based active material, a silicon-carbon based active material, or a combination thereof. In an embodiment, the active material core may include Si, SiOₓ (0≤x≤2), a Si—Z alloy (where Z is alkali metal, alkaline earth metal, a Group 13 element, a Group 14 element, a Group 15 element, a Group 16 element, a transition metal, a rare earth element, or a combination thereof, and is not Si), Sn, SnO₂, Sn—Z alloy (where Z is alkali metal, alkaline earth metal, a Group 13 element, a Group 14 element, a Group 15 element, a Group 16 element, transition metal, rare earth element or a combination thereof, and is not Sn), or a combination thereof, and at least one of these may be used in combination with SiO₂. The element Z may be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, TI, Ge, P, As, Sb, Bi, S, Se, Te, Po, or a combination thereof. These materials for the active material core may be used alone or in a combination of two or more.

In an embodiment, the active material core may include a silicon secondary particle comprising an agglomerate of silicon primary particles. When such a silicon secondary particle is included, high capacity and improved charge/discharge efficiency, resulting from the increase in the surface area of the silicon secondary particle, may be obtained.

In an embodiment, the active material core may include a silicon-carbon composite including a silicon-based material and a second carbonaceous material. In an embodiment, the active material core may include a silicon secondary particle including an agglomerate of silicon primary particles, and a second carbonaceous material including crystalline carbon, amorphous carbon or a combination thereof.

The term “silicon-based” or “silicon-containing” may be used interchangeably herein, and refer to a material which includes Si, and more specifically, is a material including greater than or equal to about 50 wt % silicon (Si), based on a total weight of the material. In an embodiment, the silicon-based material includes Si in an amount of greater than or equal to about 60 wt %, greater than or equal to about 70 wt %, greater than or equal to about 80 wt %, greater than or equal to about 90 wt %, or about 100 wt %, e.g., about 60 wt % to 100 wt %, or about 70 wt % to about 90 wt %, based on a total weight of the material. A silicon-based material may include crystalline (including single crystal, polycrystalline) silicon, amorphous silicon, or a combination thereof.

The silicon-based material may be a form of a nanostructure in which the length, diameter, width, or combination thereof of the silicon-based material may be measured in nanometers (nm), i.e., a nanoscale. The nanostructure may include a nanoparticle, a nanowire, a nanorod, a nanofiber, a nanoporous body, a nanotemplate, an acicular body, or a combination thereof.

In an embodiment, the silicon-based material may include a silicon-based nanoparticle. The average particle size of the silicon-based nanoparticle is not particularly limited within the nano size range, and may be, for example, about 500 nanometers (nm) or less, or about 250 nm or less, or about 100 nm or less. In an embodiment, the silicon-based nanoparticles may have an average particle diameter of about 1 nm to about 500 nm. In an embodiment, the silicon-based nanoparticles may have an average particle diameter of about 50 nm to about 150 nm. In an embodiment, the silicon-based nanoparticles may have an average particle diameter of about 90 nm to about 110 nm.

The silicon-carbon composite may include the second carbonaceous material. The second carbonaceous material may include crystalline carbon, amorphous carbon, or a combination thereof. The second carbonaceous material may be understood in the same manner as described in connection with the first carbonaceous material. The second carbonaceous material may include the same or different carbonaceous material as the first carbonaceous material.

Based on the total weight of the silicon-carbon composite, the amount of silicon may be in the range of about 50 wt % to about 99 wt %. In an embodiment, the amount of silicon in the silicon-carbon composite may be in the range of about 55 wt % to about 85 wt %, based on the total weight of the silicon-carbon composite. The amount of silicon in the silicon-carbon composite may be in the range of about 60 wt % to about 80 wt %, based on the total weight of the silicon-carbon composite. Within these ranges, high capacity characteristics may be obtained.

The silicon-carbon composite may form a dense structure having an apparent density of 2 grams per cubic centimeter (g/cc) or greater, e.g., about 2 g/cc to about 5 g/cc, and a porosity of less than 10%, e.g., about 0.1% to about 10%, as measured by a compression process.

The apparent density refers to the density of a porous body having closed pores. The apparent density is calculated by dividing the mass of the porous body by the sum of the volume of a solid phase portion and the volume of the closed pores. In the powder technology field, the apparent density may also be referred to as the volume density or the particle density. The apparent density of the silicon-carbon composite may be 2 g/cc or greater. In an embodiment, the apparent density of the silicon-carbon composite may be in a range of about 2 g/cc to about 2.3 g/cc. In an embodiment, the apparent density of the silicon-carbon composite may be in a range of about 2 g/cc to about 2.2 g/cc. When the apparent density of the silicon-carbon composite is within these ranges, the secondary carbon particles may have a sufficiently dense structure to improve the initial efficiency and lifespan characteristics of a lithium secondary battery.

The porosity of the silicon-carbon composite may be less than about 10%.

The term “porosity” refers to a measure of the empty space (i.e., voids or pores) in a material and is determined as a percentage of the volume of voids in a material based on the total volume of the material. The porosity may be measured by using a gas adsorption method (BET) or mercury porosimetry method. According to the gas adsorption method (BET), a gas (for example, nitrogen gas) is adsorbed by a sample and the volume of gas absorbed is used to measure the porosity of the sample and the size and distribution of pores. The mercury porosimetry method may derive the porosity based on the relationship between the mercury volume and the pressure at which mercury enters the pores, and may be measured, for example, in accordance with the method described in JIS R 1655 titled “A method of measuring a pore diameter distribution of fine ceramic molded article by mercury porosimetry,” the content of which is incorporated herein by reference in its entirety.

The silicon-carbon composite may have a porosity of less than about 10%, that is, may be in the compressed state. The porosity of the silicon-carbon composite may be 0% or greater and less than about 10%. In an embodiment, the porosity of the silicon-carbon composite may be about 1% or greater and about 8% or less. In an embodiment, the porosity of the silicon-carbon composite may be about 2% or greater and about 6% or less. When the porosity of the silicon-carbon composite is within these ranges, the secondary particles may form a dense structure which is able to improve the initial efficiency and lifespan characteristics of a lithium secondary battery.

When the porosity of the silicon-carbon composite is within these ranges, the pore distribution or the specific surface area in the secondary particles is not limited. For example, the pore size in the silicon-carbon composite, that is, the average diameter of pores may be less than about 500 nm, or less than or equal to about 250 nm, or less than or equal to about 100 nm. The average diameter of pores may be in a range of about 100 nm to about 450 nm. The specific surface area of the silicon-carbon composite may be in a range of about 6 square meters per gram (m²/g) to about 70 m²/g. In an embodiment, the specific surface area of the silicon-carbon composite may be in a range of about 20 m²/g to about 60 m²/g, or about 30 m²/g to about 50 m²/g. Within these ranges of the pore size and specific surface area, the initial efficiency and lifespan characteristics of a lithium secondary battery may be further improved. The pore size and specific surface area of the silicon-carbon composite particles may be measured by using gas adsorption (BET) or mercury porosimetry.

The average particle diameter of the silicon-carbon composite may be in a range of about 0.1 micrometer (μm) to about 15 μm. In an embodiment, the average particle diameter of the silicon-carbon composite may be in a range of about 0.5 μm to about 10 μm. In an embodiment, the average particle diameter of the silicon-carbon composite may be in a range of about 1 μm to about 5 μm. Here, the average particle diameter or D50 particle size refers to a particle diameter corresponding to 50% of the particles in a cumulative distribution curve in which particles are accumulated in the order of particle diameter from the smallest particle to the largest particle and a total number of accumulated particles is 100%, as measured by a laser diffraction method. Within these ranges of the average particle diameter, the electrical conductivity of silicon may be improved and the electrical path depending on the volume change may be obtained.

In an embodiment, the active material core includes a porous silicon composite cluster including a core and a shell, wherein the core includes a porous silicon composite secondary particle including an aggregate of two or more silicon composite primary particles, wherein the silicon composite primary particles comprise silicon, a silicon oxide disposed on the silicon, and a first graphene disposed on the silicon oxide, and wherein the shell includes a second graphene disposed on the core.

The porous silicon composite cluster is disclosed in Korean Patent Application No. 10-2016-0119557, and U.S. Patent Publication No. 2018/0083272, the contents of which are incorporated herein by reference in their entirety.

The active material core may have a porous structure or a non-porous structure.

When the active material core has a porous structure, the composite coating layer may be disposed inside of the active material core having the porous structure.

In addition, the negative active material may have a porosity which is greater than a porosity of a negative active material having a composite coating layer comprising a lithium-containing oxide which does not have the orthorhombic crystal structure. The negative active material facilitates the intercalation or deintercalation of lithium ions due to the increase in the number of pores and the increased porosity, leading to an increase in the conductivity of lithium ions.

The average particle diameter (D50) of the negative active material may be in a range of about 200 nm to about 50 μm. In an embodiment, the average particle diameter (D50) of the negative active material may be in a range of about 1 μm to about 30 μm. In an embodiment, the average particle diameter (D50) of the negative active material may be in a range of about 1 μm to about 10 μm. In an embodiment, the average particle diameter (D50) of the negative active material may be in a range of about 3 μm to about 5 μm.

In the case of an active material core which does not include a composite coating layer on a surface thereof, due to the porous structure of the active material core, the specific surface area of the active material core may be greater than about 15 m²/g, e.g., about 15 m²/g to about 100 m²/g. However, the negative active material according to embodiments may have the specific surface area of about 15 m²/g or less due to the formation of the composite coating layer. In an embodiment, the specific surface area of the negative active material may be in a range of about 1 m²/g to about 15 m²/g, or about 1 m²/g to about 10 m²/g.

The above-described negative active material may be prepared by a dry coating method using lithium oxide (Li₂O) as a lithium precursor.

A method of manufacturing a negative active material according to an embodiment includes:

providing a mixture including an active material core and a coating precursor, wherein the coating precursor includes a lithium precursor and a carbon precursor, and the lithium precursor is lithium oxide; and

heat-treating the mixture to form a composite coating layer on a surface of the active material core, wherein the composite coating layer includes a lithium-containing oxide having an orthorhombic crystal structure and a first carbonaceous material.

The mixture may be prepared by dry-mixing the active material core and the coating precursor.

The active material core is the same as described above in connection with the negative active material. In an embodiment, the active material core may include a silicon-based active material, a tin-based active material, a silicon-tin alloy based active material, a silicon-carbon based active material, or a combination thereof.

The coating precursor for forming the composite coating layer may include lithium oxide (Li₂O) as a lithium precursor and a carbon precursor.

Lithium oxide (Li₂O) is used as the lithium precursor. By using the dry mixing process using lithium oxide (Li₂O) and the heat treatment, the composite coating layer including the lithium-containing oxide having the orthorhombic crystal structure and the first carbonaceous material may be formed on the surface of the active material core. Lithium oxide (Li₂O) may react with a metal element present in the active material core during the dry mixing process and the heat treatment to form the lithium-containing oxide having the orthorhombic crystal structure.

In an embodiment, the mixture may further include a metal precursor containing a metal element selected from Si, Al, Ti, Mn, Ni, Cu, V, Zr, Nb, or a combination thereof. The metal precursor may be combined with the active material core and the coating precursor and dry-mixed together. When the amount of the metal element contained in the active material core is small, the addition of such a metal precursor may further supplement the deficiency of the metal element in order to promote formation of the lithium-containing oxide having the orthorhombic crystal structure. When a metal precursor containing a metal element other than that contained in the active material core is added, a lithium-containing oxide which has the orthorhombic crystal structure and an element different from that included in the active material core, may be formed.

The carbon precursor may be, for example, coal pitch, mesophase pitch, petroleum pitch, coal oil, petroleum heavy oil, organic synthesis pitch, a phenol resin, a furan resin, a polyimide resin, natural graphite, artificial graphite, expandable graphite, graphene, carbon nanotubes, or a combination thereof.

The dry mixing of the mixture may be performed by ball milling. An example of the ball milling may be a planetary ball milling which is a non-contact mixing method performed by rotating and revolving. By using this method, the mixture may be efficiently mixed and crushed. The ball usable for the ball milling may be, for example, a zirconia ball, and the type of the ball is not limited. The size (e.g., diameter) of the ball may be, for example, from about 0.3 mm to about 10 mm, but is not limited thereto.

In an embodiment, the ball milling may be performed for about 4 hours to about 48 hours. Various methods other than the ball milling may also be used as long as the reactants are uniformly mixed.

Thereafter, the mixture is heat treated to form the composite coating layer including the lithium-containing oxide having the orthorhombic crystal structure and the first carbonaceous material on the surface of the active material core.

In the heat treatment process, the lithium-containing oxide having the orthorhombic crystal structure is formed, and the carbon precursor is carbonized to form amorphous carbon or crystalline carbon. Through the heat treatment, a silicon component contained in the active material core may diffuse to the surface thereof, and crystalline silicon oxide may be further formed in the composite coating layer.

In an embodiment, the heat treatment may be performed at a temperature of about 500° C. to about 1,200° C. In an embodiment, the heat treatment may be performed at a temperature of about 600° C. to about 1,100° C. In an embodiment, the heat treatment may be performed at a temperature of about 700° C. to about 1,000° C. Within these temperature ranges, the composite coating layer including the lithium-containing oxide having the orthorhombic crystal structure and the first carbonaceous material may be formed on the surface of the active material core.

The heat treatment time is not limited, and may be in a range of about 10 minutes to about 5 hours.

A lithium secondary battery according to another embodiment includes a negative electrode including the above-described negative active material; a positive electrode disposed to face the negative electrode; and an electrolyte between the negative electrode and the positive electrode.

The negative electrode may include the negative active material according to embodiments described above. The negative electrode may be manufactured as follows: a negative active material, a binder, and optionally a conductive agent, are mixed in a solvent to prepare a negative active material composition, which is then molded into a given shape or coated on a copper foil.

The negative electrode may further include a second negative active material in addition to the negative active material described herein. The second negative active material may be any material suitable for use as a negative active material for a lithium battery. A material for a second negative active material that may include, for example, lithium metal, a lithium-alloyable metal, a transition metal oxide, a non-transition metal oxide, a carbonaceous material, or a combination thereof.

In an embodiment, the lithium-alloyable metal may be Si, Sn, Al, Ge, Pb, Bi, Sb, a Si—Y alloy (where Y is an alkali metal, an alkaline earth metal, a Group 13 element, a Group 14 element, a Group 15 element, a Group 16 element, a transition metal, a rare earth element, or a combination thereof, and is not Si), or a Sn—Y alloy (where Y is an alkali metal, an alkaline earth metal, a Group 13 element, a Group 14 element, a Group 15 element, a Group 16 element, a transition metal, a rare earth element, or a combination thereof, and is not Sn). The element Y may be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, TI, Ge, P, As, Sb, Bi, S, Se, Te, Po, or a combination thereof.

In an embodiment, the transition metal oxide may be lithium titanium oxide, vanadium oxide, lithium vanadium oxide, or a combination thereof.

In an embodiment, the non-transition metal oxide may be SnO₂, SiOₓ (0≤x≤2), or a combination thereof.

The carbonaceous material may be crystalline carbon, amorphous carbon, or a combination thereof. The crystalline carbon may be graphite, such as artificial graphite, or natural graphite that is non-shaped, or has a tabular, flake, spherical, or fibrous shape. The amorphous carbon may be soft carbon, hard carbon, mesophase pitch carbide, calcinated coke, or a combination thereof.

When the negative active material according to an embodiment and a carbonaceous material are used together, the oxidation reaction of a silicon-based active material is inhibited, a SEI film is effectively formed to form a stable film, and the electric conductivity is improved, and charging and discharging characteristics may be improved.

Any suitable negative electrode materials may be mixed and blended with the negative active material described above, or coated on the surface of the negative active material described above, or used in any other suitable combination or form.

The binder used in the negative active material composition is a component that assists in binding of a negative active material and a conductive agent and bonding to a current collector. The binder may be used in an amount of about 1 part by weight to about 50 parts by weight, based on 100 parts by weight of a negative active material. The amount of the binder may be in a range of about 1 part by weight to about 30 parts by weight, based on 100 parts by weight of the negative active material. In an embodiment, the amount of the binder may be in a range of about 1 part by weight to about 20 parts by weight, based on 100 parts by weight of the negative active material. In an embodiment, the amount of the binder may be in a range of about 1 part by weight to about 15 parts by weight, based on 100 parts by weight of the negative active material. Examples of the binder include polyvinylidene fluoride (PVDF), polyvinylidene chloride, polybenzimidazole, polyimide, polyvinyl acetate, polyacrylonitrile, polyvinyl alcohol, carboxymethylcellulose (CMC), starch, hydroxypropyl cellulose, regenerated celluloses, polyvinylpyrrolidone, tetrafluoroethylene, polyethylene, polypropylene, polystyrene, polymethyl methacrylate, polyaniline, acrylonitrile butadiene styrene, phenol resin, epoxy resin, polyethylene terephthalate, polytetrafluoroethylene (PTFE), polyphenylsulfide, polyamideimide, polyetherimide, polyethylene sulfone, polyamide, polyacetal, polyphenylene oxide, polybutylene terephthalate, ethylene-propylene-diene terpolymer (EPDM), sulfonated EPDM, styrene butadiene rubber, fluorine rubber, copolymers thereof, or a combination thereof.

The negative electrode may further include a conductive agent to improve electrical conductivity by providing a conductive path to the negative active material. The conductive agent may be any material that is suitable for use in a lithium battery, and examples thereof include a carbonaceous material, such as carbon black, acetylene black, ketjen black, or carbon fiber (for example, vapor-grown carbon fiber); a metal-based material such as a metal powder or a metal fiber, such as copper, nickel, aluminum, or silver; a conductive polymer such as a polyphenylene derivative; or a combination thereof. The amount of the conductive agent may be appropriately adjusted. In an embodiment, the weight ratio of the negative active material and the conductive agent may be in a range of about 99:1 to about 90:10.

As the solvent, N-methylpyrrolidone (NMP), acetone, water or a combination thereof may be used. The amount of solvent may be in the range of about 10 part by weight to about 200 parts by weight, based on 100 parts by weight of the negative active material. When the amount of the solvent is within the above range, the active material layer may be easily prepared.

The current collector may have a thickness of about 3 μm to about 500 μm. The current collector may be any material that has electronic conductivity while not causing a chemical change in a corresponding battery, and examples of a material for forming the current collector include copper, stainless steel, aluminum, nickel, titanium, calcined carbon; copper and stainless steel, surface-treated with carbon, nickel, titanium, silver, or the like; an aluminum-cadmium alloy, or a combination thereof. In an embodiment, uneven fine structures may be formed on the surface of the negative electrode current collector to enhance the bonding force of the negative active material, to the negative electrode current collector. The negative electrode current collector may be used in various forms such as a film, a sheet, a foil, a net, a porous body, a foam, or a nonwoven fabric.

The negative active material composition may be directly coated on the current collector to produce a negative electrode plate, or alternatively, may be cast onto a separate support and a negative active material film exfoliated from the substrate is laminated on a copper current collector, thereby obtaining a negative electrode plate. The negative electrode is not limited to those described above, and may be of other forms.

The negative active material composition may be used in manufacturing an electrode for a lithium secondary battery, and may be printed on a flexible electrode substrate for the manufacture of a printable battery.

Separately, provided is a positive active material composition in which a positive active material, a conductive agent, a binder and a solvent are mixed.

The positive active material may be any lithium-containing metal material which is suitable for use as a positive active material.

In an embodiment, the positive active material may be a compound represented by one of LiₐA_{1-b}B′_{b}D₂ (where 0.90≤a≤1.8, and 0≤b≤0.5); LiₐE_{1-b}B′_{b}O_{2-c}D_{c} (where 0.90≤a≤1.8, 0≤b≤0.5, and 0≤c≤0.05); LiE_{2-b}B′_{b}O_{4-c}D_{c} (where 0≤b≤0.5 and 0≤c≤0.05); LiₐNi_{1-b-c}CO_{b}B′_{c}D_{α} (where 0.90≤a≤1.8, 0≤b≤0.5, 0≤c≤0.05, and 0<α≤2); LiₐNi_{1-b-c}CO_{b}B′_{c}O_{2-α}F′_{α} (where 0.90≤a≤1.8, 0≤b 0.5, 0≤c≤0.05, and 0<α<2); LiₐNi_{1-b-c}CO_{b}B′_{c}O_{2-α}F′₂ (where 0.90≤a≤1.8, 0≤b≤0.5, 0≤c≤0.05, and 0≤a≤2); LiₐNi_{1-b-c}Mn_{b}B′_{c}D_{α} (where 0.90≤a≤1.8, 0≤b≤0.5, 0≤c≤0.05, and 0<α≤2); LiₐNi_{1-b-c}Mn_{b}B′_{c}O_{2-α}F′_{α} (where 0.90≤a≤1.8, 0≤b≤0.5, 0≤c≤0.05, and 0<α≤2); LiₐNi_{1-b-c}Mn_{b}B_{c}O_{2-α}F′₂ (where 0.90≤a≤1.8, b≤0.5, 0≤c≤0.05, and 0<α<2); LiₐNi_{b}E_{c}G_{d}O₂ (where 0.90≤a≤1.8, b≤0.9, 0≤c≤0.5, 0.001≤d≤0.1); LiₐNi_{b}Co_{c}Mn_{d}GeO₂ (where 0.90≤a≤1.8, 0≤b≤0.9, 0≤c≤0.5, 0≤d≤50.5, and 0.001≤e≤0.1); LiₐNiG_{b}O₂ (where 0.90≤a≤1.8 and 0.001≤b≤0.1); LiₐCoG_{b}O₂ (where 0.90≤a≤1.8 and 0.001≤b≤0.1); LiₐMnG_{b}O₂ (where 0.90≤a≤1.8 and 0.001≤b≤0.1); LiₐMn₂G_{b}O₄ (where 0.90≤a≤1.8 and 0.001≤b≤≤0.1); QO₂; QS₂; LiQS₂; V₂O₅; LiV₂O₅; LiI′O₂; LiNiVO₄; Li_{(3-f)}J₂(PO₄)₃(0≤f≤2); Li_{(3-f)}Fe₂(PO₄)₃(0≤f≤2); and LiFePO₄.

In the chemical formulae above, A is Ni, Co, Mn, or a combination thereof; B′ is Al, Ni, Co, Mn, Cr, Fe, Mg, Sr, V, a rare-earth element, or a combination thereof; D is O, F, S, P, or a combination thereof; E is Co, Mn, or a combination thereof; F′ is F, S, P, or a combination thereof; G is Al, Cr, Mn, Fe, Mg, La, Ce, Sr, V, or a combination thereof; Q is Ti, Mo, Mn, or a combination thereof; I′ is Cr, V, Fe, Sc, Y, or a combination thereof; and J is V, Cr, Mn, Co, Ni, Cu, or a combination thereof.

These compounds may have a coating layer on their surfaces. In one or more embodiments, these compounds may be used together with a compound having a coating layer. The coating layer may include a coating element compound, such as an oxide of a coating element, a hydroxide of a coating element, an oxyhydroxide of a coating element, an oxycarbonate of a coating element, or a hydroxycarbonate of a coating element. Compounds constituting these coating layers may be amorphous or crystalline. As a coating element included in a coating layer, Mg, Al, Co, K, Na, Ca, Si, Ti, V, Sn, Ge, Ga, B, As, Zr, or a combination thereof may be used. A coating layer may be formed by using any suitable method, and which does not adversely affect the properties of a positive active material (for example, a spray coating, an immersion method, or the like). These coating methods are understood by one of ordinary skill in the art, and thus, a detailed description thereof will be omitted.

For example, LiNiO₂, LiCoO₂, LiMnₓO₂ₓ (x=1, 2), LiNi₁₋ₓMnₓO₂(0≤x≤1), LiNi_{1-x-y}CoₓMn_{y}O₂(0≤x≤0.5, 0≤y≤0.5), LiFeO₂, V₂O₅, TiS, MoS, or a combination thereof may be used.

The conductive agent, the binder, and the solvent for the positive active material composition may be the same as described above in connection with the negative active material composition. If desired, a plasticizer may be further added to the positive active material composition and the negative active material composition to form pores inside an electrode plate. The amounts of the positive active material, the conductive agent, the binder, and the solvent used for the positive electrode may be determined by a person of skill in the art without undue experimentation.

The current collector for the positive electrode may have a thickness of about 3 μm to about 100 μm. A material for the current collector is not limited as long as the material has high conductivity while not causing any chemical change in a corresponding battery. A material for the current collector may be stainless steel, aluminum, nickel, titanium, calcined carbon; or aluminum or stainless steel, surface-treated with carbon, nickel, titanium, silver, or the like. In an embodiment, uneven fine structures may be formed on the surface of the current collector to increase the bonding force of the positive active material to the current collector. The current collector may be used in various forms such as a film, a sheet, a foil, a net, a porous body, a foam, or a nonwoven fabric.

The prepared positive active material composition may be coated and dried directly on the positive electrode current collector to produce a positive electrode plate. In one or more embodiments, the positive active material composition is cast on a separate support, and then a film exfoliated from the support is laminated on the positive electrode current collector to prepare the positive electrode plate.

The positive electrode and the negative electrode may be separated by a separator, and the separator may be any suitable material that is used for a lithium battery. For example, the separator may be form of a material that has a low resistance to ion migration of an electrolyte and has an excellent electrolytic solution-retaining capability. For example, the material for forming the separator may be selected from glass fiber, polyester, Teflon, polyethylene, polypropylene, polytetrafluoroethylene (PTFE), and a combination thereof, each of which may be a non-woven or woven form. The separator may have a pore diameter of about 0.01 μm to about 10 μm, and a thickness of about 5 μm to about 300 μm.

A lithium salt-containing non-aqueous electrolyte consists of a non-aqueous electrolyte and lithium salt. The non-aqueous electrolyte may be a non-aqueous electrolyte solution, an organic solid electrolyte, an inorganic solid electrolyte, or a combination thereof.

An example of the non-aqueous electrolyte solution is an aprotic organic solvent including N-methyl-2-pyrrolidinone, propylene carbonate, ethylene carbonate, butylene carbonate, dimethyl carbonate, diethyl carbonate, gamma-butyrolactone, 1,2-dimethoxy ethane, tetrahydrofuran, 2-methyl tetrahydrofuran, dimethylsulfoxide, 1,3-dioxolane, formamide, dimethylformamide, acetonitrile, nitromethane, methyl formate, methyl acetate, triester phosphate, trimethoxy methane, dioxorane derivative, sulfolane, methyl sulfolane, 1,3-dimethyl-2-imidazolidinone, propylene carbonate derivative, tetrahydrofuran derivative, ether, methyl propionate, ethyl propionate, or a combination thereof.

The organic solid electrolyte may be, for example, a polyethylene derivative, a polyethylene oxide derivative, polypropylene oxide derivative, phosphoric acid ester polymer, poly-L-lysine, poly ester sulfide, polyvinyl alcohol, polyvinylidene fluoride, a polymer including an ionic dissociation group, or a combination thereof.

The inorganic solid electrolyte may be, for example, the oxide, nitride, halide, or sulfide of Li, such as Li₃N, LiI, Li₅NI₂, Li₃N—LiI—LiOH, LiSiO₄, LiSiO₄—LiI—LiOH, Li₂SiS₃, Li₄SiO₄, Li₄SiO₄—LiI—LiOH, Li₃PO₄—Li₂S—SiS₂, or a combination thereof.

The lithium salts may be any material suitable for use in a lithium battery. A lithium salt which is easily dissolved in the non-aqueous electrolyte may include, for example, LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, (CF₃SO₂)₂NLi, lithium chloroborate, low aliphatic lithium carbonate, 4-phenyl lithium borate, a lithium imide, or a combination thereof.

Lithium secondary batteries are classified as a lithium ion battery, a lithium ion polymer battery, and a lithium polymer battery, depending on the type of the separator and the electrolyte used. Lithium secondary batteries may have a cylindrical shape, a square shape, a coin shape, a pouch shape, or the like, depending on the intended use. Lithium secondary batteries are classified as a bulk type battery and a thin type battery, depending on the size.

Methods for manufacturing a lithium battery are known to those of skill in the art, and therefore, a detailed description thereof will be omitted.

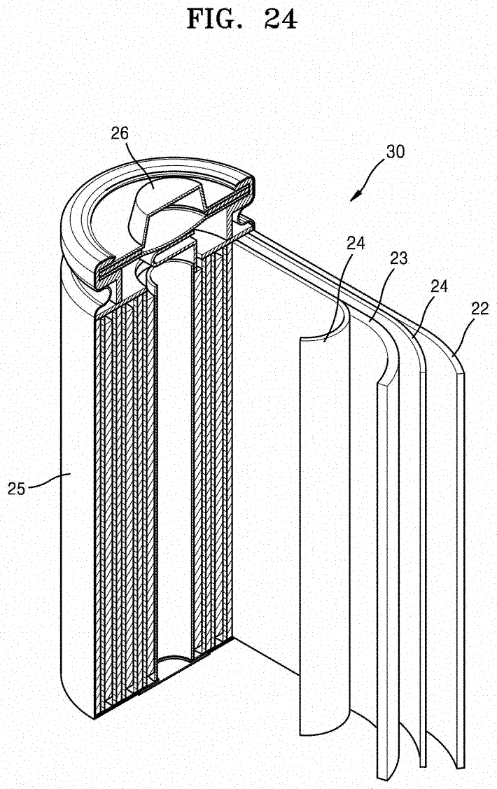

FIG. 24 shows a schematic view of a lithium secondary battery 30 according to an embodiment of the present disclosure.

Referring to FIG. 24, the lithium secondary battery 30 includes a positive electrode 23, a negative electrode 22, and a separator 24 between the positive electrode 23 and the negative electrode 22. The positive electrode 23, the negative electrode 22, and separator 24 are wound or folded and housed in a battery case 25. Subsequently, an electrolyte is provided to a battery case 25, followed by sealing with an encapsulation member 26, thereby completing the manufacture of a lithium secondary battery 30. The battery case 25 may have a cylindrical shape, a rectangular shape, a thin film shape, or the like. The lithium secondary battery 30 may be a lithium ion battery.

The lithium secondary battery 30 may be used as a power source for a small device, such as a mobile phone or a portable computer, and also in a unit battery of a middle or large sized device battery module including a plurality of batteries.

An example of a middle or large sized device is a power tool; xEV, such as an electric vehicle (EV), a hybrid electric vehicle (HEV), or a plug-in hybrid electric vehicle (PHEV); an electric bicycle, such as an E-bike or an E-scooter; an electric golf cart; an electric truck; an electric commercially available vehicle; or a power storage system, but is not limited thereto. Furthermore, the lithium secondary battery 30 may be used for other applications in which high output, high voltage and high-temperature driving are desired features.

Embodiments of the present disclosure will be described in more detail with reference to the following examples and comparative examples. These examples are provided herein for illustrative purpose only, and do not limit the scope of the present disclosure.

### Example 1

### (1) Preparation of Negative Active Material

### A) Preparation of Active Material Core

25 parts by weight of planar and needle-shaped silicon was mixed with 10 parts by weight of stearic acid and 65 parts by weight of isopropyl alcohol, and the obtained composition was spray-dried to obtain a porous silicon composite secondary particle having an average particle diameter of about 4.5 μm.

The spray-drying was performed under an N₂ atmosphere while the size and pressure of the spray nozzle were controlled and the powder spray atmospheric temperature (about 200° C.) was controlled, to dry out (evaporate) the isopropyl alcohol and prepare a porous silicon composite secondary particle.

The porous silicon composite secondary particle was located inside a reactor. The reactor was filled with nitrogen gas, and then, a gas mixture (CH₄:CO₂=80:20 by volume) was provided as a reactant gas into the reactor to make the reactor to be under the atmosphere of the gas. The pressure caused by the flow of the gas in the reactor was 1 atmosphere (atm). Under the gas atmosphere, the inner temperature of the reactor was increased to 1,000° C. (a temperature incremental rate: about 23° C./min), and while the gas was continuously allowed to flow into the reactor, the temperature was maintained constant for 1 hour to perform a heat treatment. Then, the result was left for about 3 hours. Then, the supply of the gas was stopped, and the reactor was cooled to room temperature (25° C.), and the reactor was filled with nitrogen to obtain a porous silicon composite cluster.

### B) Formation of Composite Coating Layer

The surface of the silicon carbon composite was surface-treated as follows to form a composite coating layer.

30 parts by weight of coal tar pitch and 5 parts by weight of lithium oxide were added to a planetary mill based on 100 parts by weight of the porous silicon composite cluster, and then, dry milling was performed thereon. The planetary mill is a mixer that rotates and revolves while in non-contact with a composition. The dry milling was performed at the rate of 1,300 rotations per minute (rpm) for 5 minutes.

Then, the result was heat treated in an atmosphere of argon gas and at a temperature of 900° C. for 3 hours.

### (2) Manufacture of Coin Half Cell

A negative active material prepared as described above and a binder (polyvinylacetate-polyacrylic acid, PVA-PAA) were uniformly mixed at a weight ratio of 97:3 to prepare negative electrode slurry.

The negative electrode slurry was coated on a copper foil current collector having a thickness of 10 μm, and the resultant coated electrode plate was dried at a temperature of 120° C. for 2 hours, followed by pressing, thereby completing the manufacture of a negative electrode. The negative electrode had an electrode specific capacity of 550 milliampere hours per gram (mAh/g) and an electrode density of 1.5 g/cc.

The negative electrode, a counter electrode formed of metal lithium, a polyethylene (PE) separator, and an electrolyte in which 1 molar (M) LiPF₆ was dissolved in a mixed solvent including ethylene carbonate (EC), diethylcarbonate (DEC), fluoroethylcarbonate (FEC) in a volumetric ratio of 5:70:25, to manufacture the coin half cell of CR2032 type.

### (3) Manufacture of Coin Full Cell

The negative electrode was used in the coin half cell, and a positive electrode was manufactured as follows. LiNi_{0.6}Co_{0.2}Mn_{0.2}O₂, which is a positive active material, and PVA-PAA, which is a binder, were mixed at a weight ratio of 1:1 to prepare a positive electrode slurry, and the positive electrode slurry was coated on an aluminum foil current collector having a thickness of 12 μm. Once the coating was completed, the resultant electrode plate was dried at a temperature of 120° C. for 15 minutes, followed by pressing, thereby completing the manufacture of a positive electrode.

A CR2032-type coin full cell was manufactured by using the positive electrode, the negative electrode, a PTFE separator (PVDFs), 1.3M LiPF₆ dissolved in a mixed solvent including ethylene carbonate (EC), ethylmethyl carbonate (EMC), and diethylcarbonate (DEC) in a volumetric ratio of 3:5:2, which is an electrolyte.

### Comparative Example 1

A negative active material was prepared in the same manner as in Example 1, except that 30 parts by weight of coal tar pitch based on 100 parts by weight of the porous silicon composite cluster was used to form a pitch coating.

A coin half cell and a coin full cell were manufactured in the same manner as in Example 1 except that the negative active material was used.

### Comparative Example 2

A negative active material was prepared in the same manner as in Example 1, except that 5 parts by weight of lithium oxide based on 100 parts by weight of the porous silicon composite cluster was used to form a Li₂SiO₃ coating alone.

A coin half cell and a coin full cell were manufactured in the same manner as in Example 1 except that the negative active material was used.

### Comparative Example 3

A negative active material, a coin half cell, and a coin full cell were manufactured in the same manner as in Example 1 except that lithium hydroxide was used instead of Li₂O.

### Comparative Example 4

A negative active material, a coin half cell, and a coin full cell were manufactured in the same manner as in Example 1 except that lithium acetate was used instead of Li₂O.

### Evaluation Example 1: XRD and FT-IR Analysis

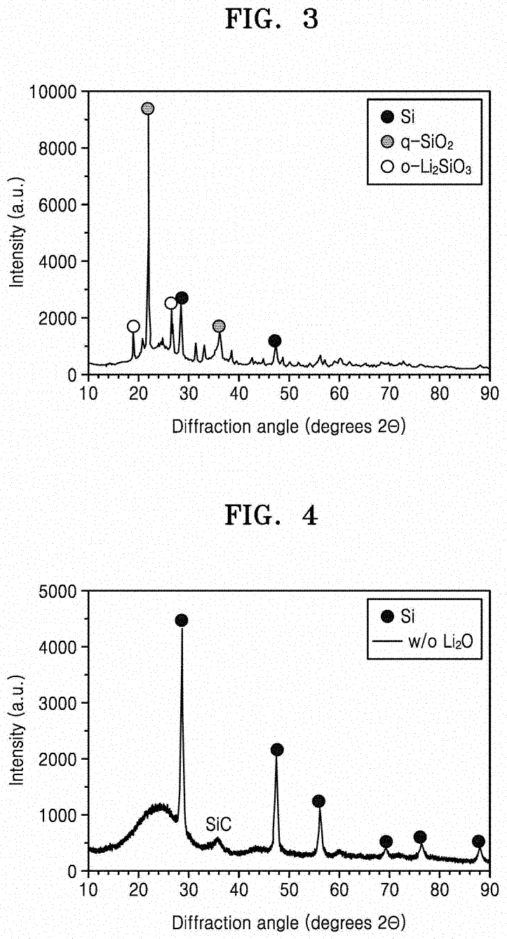

X-ray diffraction (XRD) experiments were performed on the negative active materials prepared in Example 1 and Comparative Example 1, and the results are shown in FIGS. 3 and 4. XRD was measured by using a Cu-Kα ray.

As shown in FIGS. 3 and 4, in the case of Comparative Example 1, only a carbon coating layer was formed on the porous silicon composite cluster, whereas in the case of Example 1 in which Li₂O was added and heat treated, an o-Li-silicate phase (orthorhombic) and q-SiO₂ phase were formed.

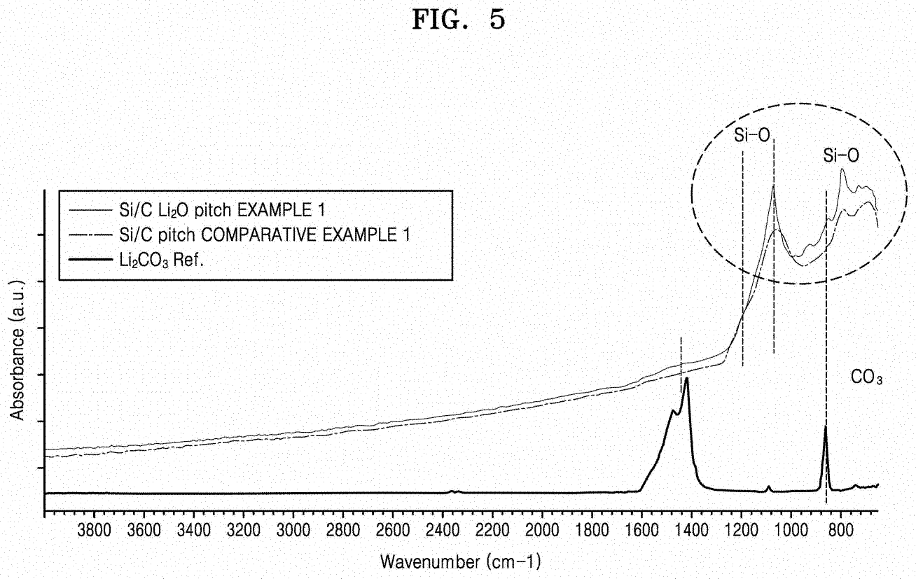

Fourier transform infrared (FT-IR) analysis was performed on the negative active materials prepared according to Example 1 and Comparative Example 1, and the results are shown in FIG. 5. For reference, FT-IR results obtained by using the negative active material coated with Li₂CO₃ are shown together in FIG. 5.

As shown in FIG. 5, in the case of Comparative Example 1, even after the high-temperature treatment, silicon oxide present on the silicon surface retained its amorphous state, whereas in the case of Example 1, the treatment with lithium-containing oxide resulted in the conversion into high-crystalline silicon oxide. In general, amorphous silicon oxide causes irreversible reaction with lithium in the evaluation of batteries, resulting in deterioration of cell-performance, whereas crystalline silicon oxide may not react with lithium or reversibly react with lithium to improve cell-performance.

### Evaluation Example 2: Scanning Electron Microscopic (SEM), Transmission Electron Microscopic (TEM), and Secondary Ion Mass Spectrometry (SIMS) Analysis

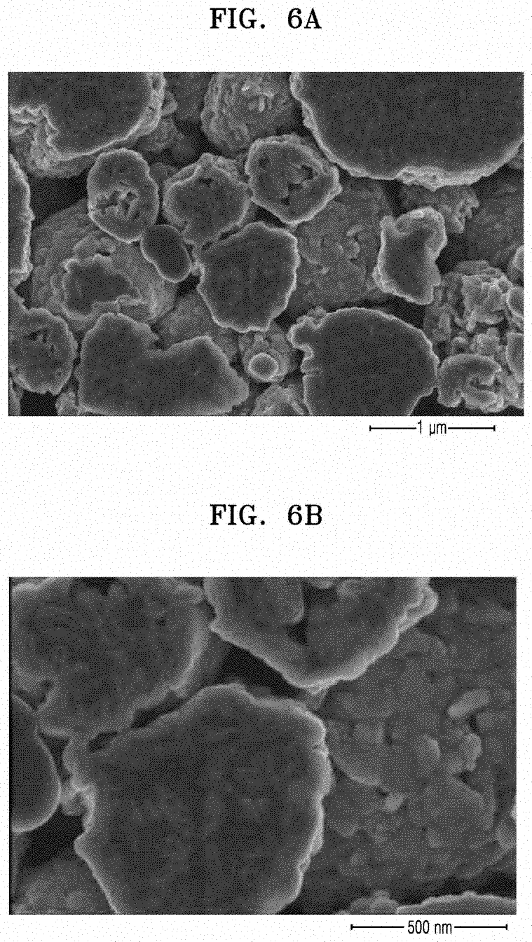

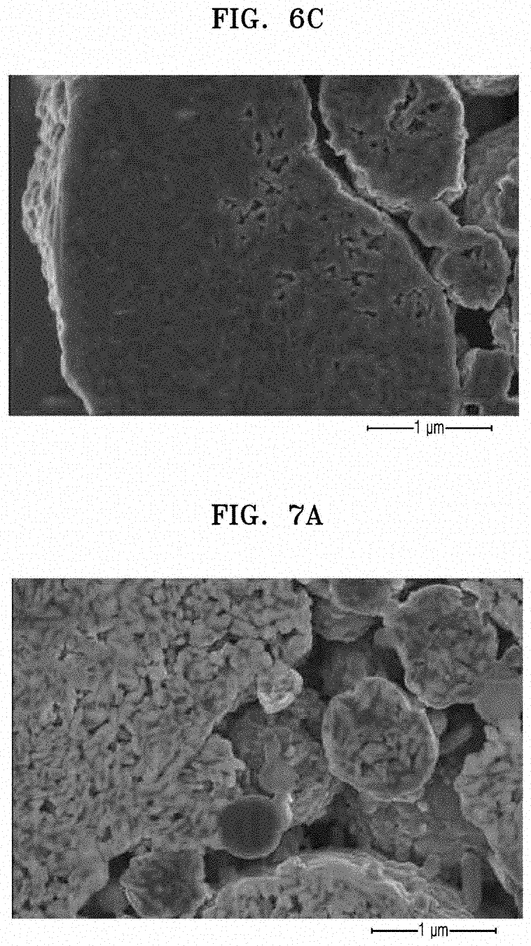

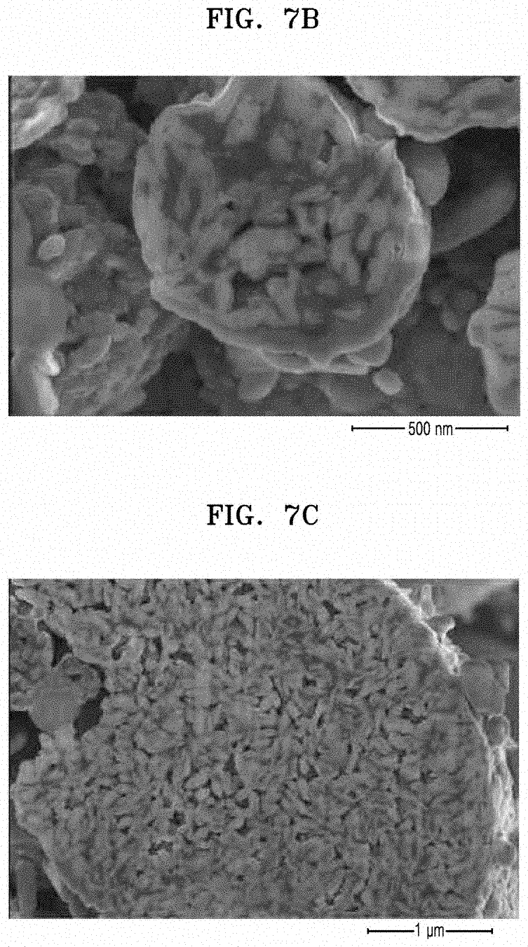

First, SEM analysis was performed on cross-sections of the negative active materials prepared in Comparative Example 1 and Example 1, and the result of Comparative Example 1 was compared with the result of Example 1. SEM photographs of the negative active material prepared according to Comparative Example 1 are shown in FIGS. 6A to 6C, and SEM photographs of the negative active material prepared according to Example 1 are shown in FIGS. 7A to 7C.

As shown in FIGS. 6A to 6C and FIGS. 7A to 7C, the negative active material of Example 1 prepared by adding LiO to the pitch coating and performing heat treatment thereon provides a composite coating layer that is different from that of Comparative Example 1 in which only pitch coating was performed, and the negative active material of Example 1 had larger primary particles and more pores between adjacent particles thereof than those of Comparative Example 1.

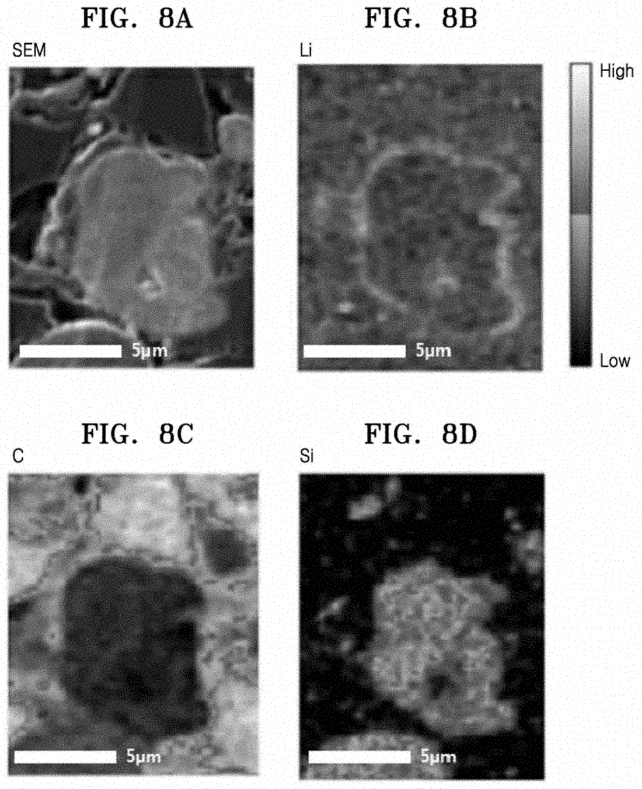

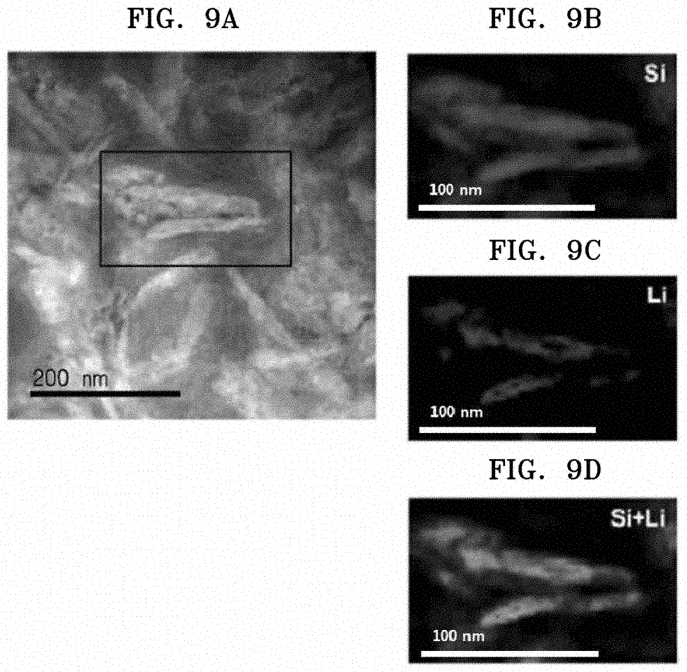

Components constituting cross-sections of the negative active material prepared according to Example 1 were analyzed by SEM, TEM, and SIMS. The SEM image and the element mapping result of the cross-section of the negative active material are shown in FIG. 8, and the TEM image thereof is shown in FIG. 9.

As shown in FIGS. 8 and 9, it was confirmed that carbon and the lithium silicate phase were relatively uniformly present on the surface of secondary particles of the active material core, and carbon and the lithium silicate phase were also coated on the surface of the silicon primary particles located inside the negative active material. Such a surface-treatment layer prevents the direct exposure of an active material core to an electrolytic solution and reduces the resistance of the lithium deintercalation/intercalation reaction during charging and discharging, thereby contributing to the improvement of the cell-performance.

### Evaluation Example 3: Evaluation of Characteristics of a Battery According to the Formation of a Composite Coating Layer (1)

The capacity retention ratio per cycle and the coulombic efficiency for the coin half cell and the coin full cell prepared according to each of Example 1 and Comparative Example 1 were evaluated as follows.

The coin half cell and the coin full cell prepared according to each of Example 1 and Comparative Example 1 were charged with a constant current of 0.1 C rate at a temperature of 25° C. until the voltage reached 0.01 volt (V) (vs. Li), and then, charged with a constant voltage until the current reached 0.01 C. After the charged cells were remained left for 10 minutes, the cells were discharged with a constant current of 0.1 C until the voltage reached 1.5 V (vs. Li) at the time of discharging (1^{st} cycle).

Then, the cells were charged with a constant current of 0.2 C rate until the voltage reached 0.01 V (vs. Li), and charged with a constant voltage until the current reached 0.01 C while maintaining the voltage at 0.01 V (CC-CV). After the charged cells were remained left for 10 minutes, the cells were discharged with a constant current of 0.2 C until the voltage reached 1.5 V (vs. Li) at the time of discharging (2^{nd} cycle) (1^{st} and 2^{nd} cycles correspond to a formation process).

Then, the cells which had been subjected to the formation process were charged with a constant current of 1.0 C rate at a temperature of 25° C. until the voltage reached 0.01 V (vs. Li), and charged with a constant voltage until the current reached 0.01 C while maintaining the voltage at 0.01 V. After the charged coin cells were remained left for 10 minutes, the cells were discharged with a constant current of 1.0 C until the voltage reached 1.5 V (vs. Li) at the time of discharging. This cycle was repeatedly performed 100 times.

The initial efficiency, capacity retention ratio and coulombic efficiency were calculated from the following Equations 1, 2, and 3, respectively.

Initial efficiency[%]=[discharge capacity in 1^{st} cycle/charge capacity in 1^{st} cycle]×100% Equation 1

Capacity retention ratio(CRR)[%]=[discharge capacity in 53^{rd} cycle/discharge capacity in 3^{rd} cycle]×100% Equation 2

Coulombic efficiency[%]=[discharge capacity in each cycle/charge capacity in each cycle]×100% Equation 3

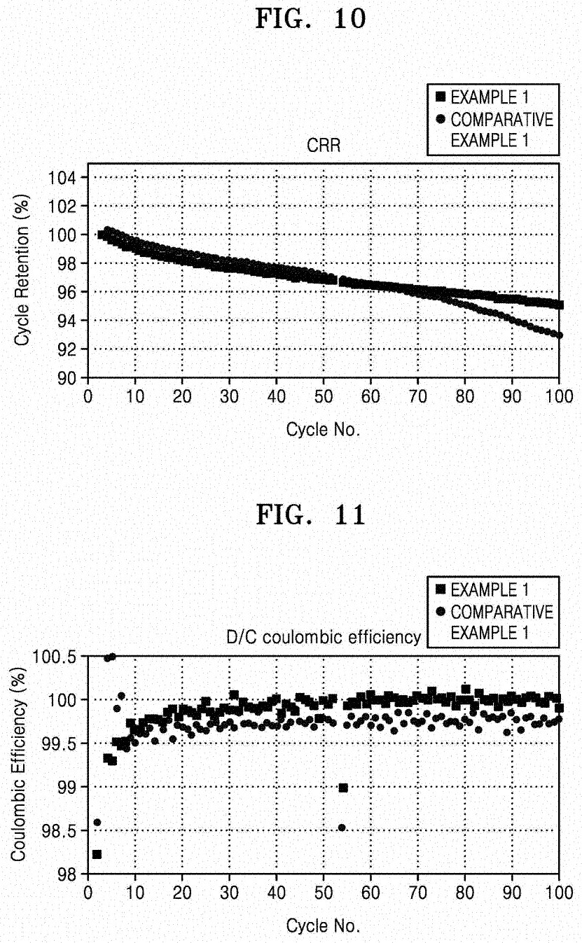

The measurements of the capacity retention ratio of the coin half cell manufactured according to each of Example 1 and Comparative Example 1 are shown in FIG. 10, and the measurements of coulombic efficiency per cycle thereof are shown in FIG. 11.

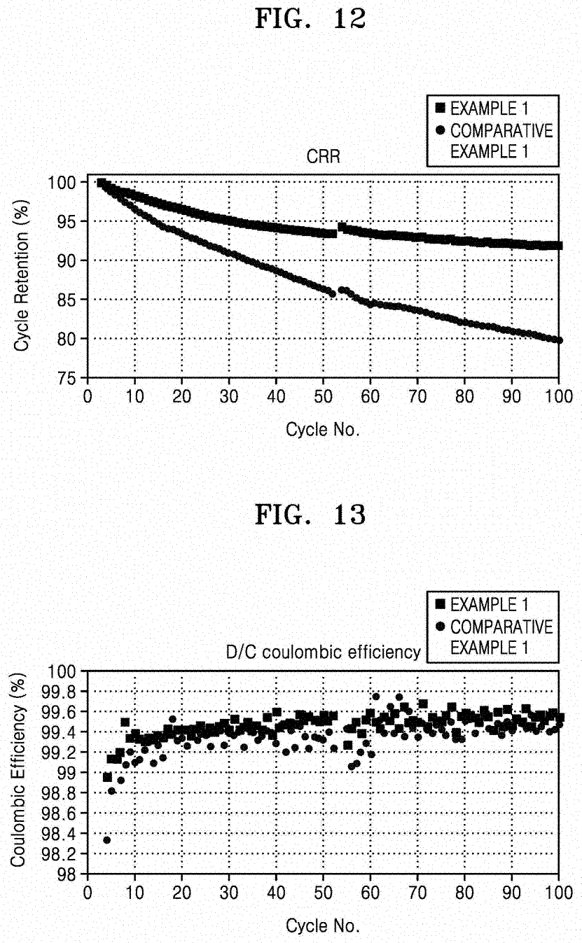

The measurements of the capacity retention ratio of the coin full cell manufactured according to each of Example 1 and Comparative Example 1 are shown in FIG. 12, and the measurements of coulombic efficiency per cycle thereof are shown in FIG. 13.

In addition, the electrode density, current density, loading amount (L/L), initial efficiency (ICE), discharge capacity at 0.2 C, and capacity retention ratio (CRR) after 100 cycles of the coin half cell and coin full cell manufactured according to each of Example 1 and Comparative Example (CE) 1, are shown in Table 1.

TABLE 1

| | | | | | | 0.2 C | CRR (% |
|---|---|---|---|---|---|---|---|
| | | Electrode | Current | | | Discharge | @100 |
| Cell | | density | density | L/L | ICE | Capacity | cycle, |
| type | Sample | (g/cc) | (mAh/cm²) | (mg/cm²) | (%) | (mAh/g) | 1 C) |
| Half | CE 1 | 1.66 | 3.75 | 7.73 | 86.8 | 417 | 92.5 |
| cell | Example 1 | 1.59 | 3.62 | 7.45 | 87.08 | 420.48 | 95.06 |
| Full | CE 1 | 1.82 | 5.94 | 11.13 | 73.06 | 140.12 | 79.37 |
| cell | Example 1 | 1.77 | 5.34 | 10.00 | 80.02 | 153.89 | 91.72 |

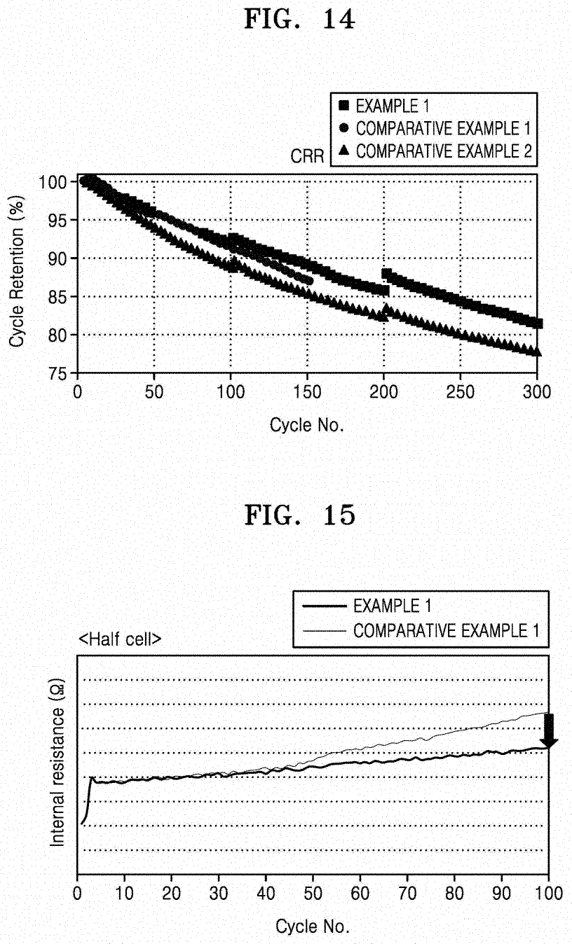

In addition, an electrode plate was manufactured in the same manner as used to manufacture a coin cell in Example 1 and Comparative Examples 1 and 2, and a 18650 type circular cell was assembled. Each cell was subjected to a formation process and a cyclic evaluation under the same condition as a coin cell under a charging voltage of 4.2 V at a temperature of 25° C. and a discharge voltage of 2.8 V (vs. Li/Li), and the capacity retention ratio of each cell was measured. Results are shown in FIG. 14.

As shown in the results above, the evaluation results of the cell-performance of the negative electrode itself and the cell-performance of the negative active material when used together with the positive electrode, which was confirmed by the tests on the half cell and the full cell manufactured according to Example 1, show that the initial efficiency and the lifespan characteristics after 100 cycles were all improved.

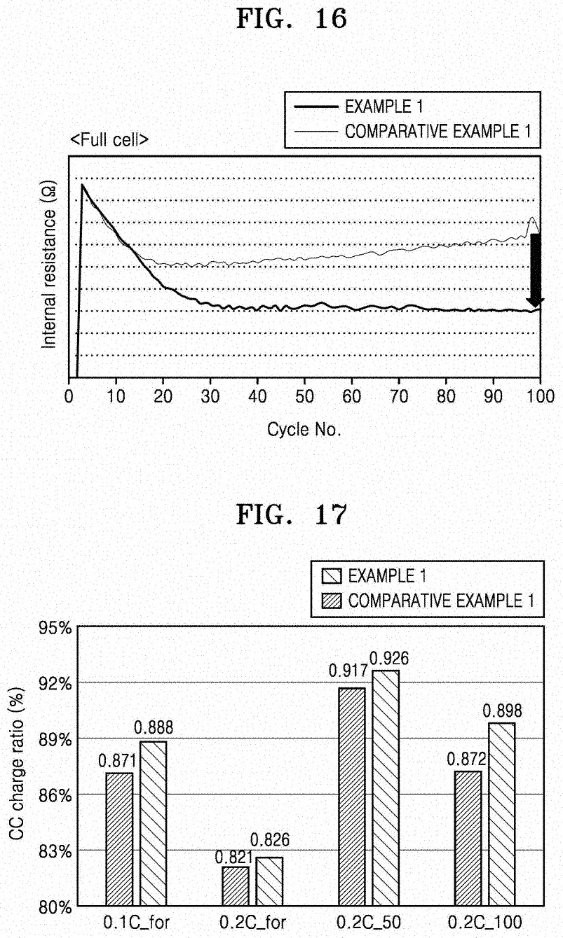

By the internal resistance measurement obtained by comparing cycle design open circuit voltage (OCV) and cycle design closed circuit voltage (CCV), resistance values of lithium per cycle with respect to deintercalation and intercalation reactions were calculated, and the measurements of the internal resistance per cycle of the coin half cell and the coin full cell are shown in FIGS. 15 and 16, respectively.

As illustrated in FIGS. 15 and 16, regarding Example 1 and Comparative Example 1, resistance was increased as the number of cycles increased. However, in the case of Example 1, the incremental rate was relatively small. This result shows that the resistance due to the formation of the surface SEI or electric short-circuiting of an active material was reduced by the surface treatment with a lithium-containing oxide composite.

Rate characteristics of the coin full cells manufactured according to Example 1 and Comparative Example 1 were evaluated by comparing the constant current/constant voltage charging results and constant current charging results in the formation process at 0.1 C and in the cycle at 0.2 C, and CC charge ratios calculated according to Equation 4 are shown in FIG. 17.

$$* CC charge ratio = \frac{CC charging capacity}{CC + CV charging capacity} \qquad Equaton 4$$

Herein, the CC charging capacity refers to a charge capacity in the CC section, and the CC+CV charging capacity refers to the sum of the charge capacity of the CC section and the charge capacity of the CV section.

As illustrated in FIG. 17, as in Example 1, when a composite coating layer including a lithium-containing oxide and carbon was formed on the surface of an active material core, rate characteristics were improved compared to when only carbon coating layer was formed.

### Evaluation Example 4: Evaluation of Battery Characteristics for Confirming the Coating Effect According to the Type of Lithium Precursor (2)

To identify effects of a lithium precursor used for the surface treatment, in Example 1 and Comparative Examples 3 and 4, the same surface-treatment test was performed by using various lithium precursors (Li-oxide, Li-hydroxide, and Li-acetate).

The capacity retention ratio per cycle and coulombic efficiency of the coin half cell and the coin full cell manufactured according to each of Example 1 and Comparative Examples 3 and 4 were evaluated in the same manner as in Evaluation Example 3.

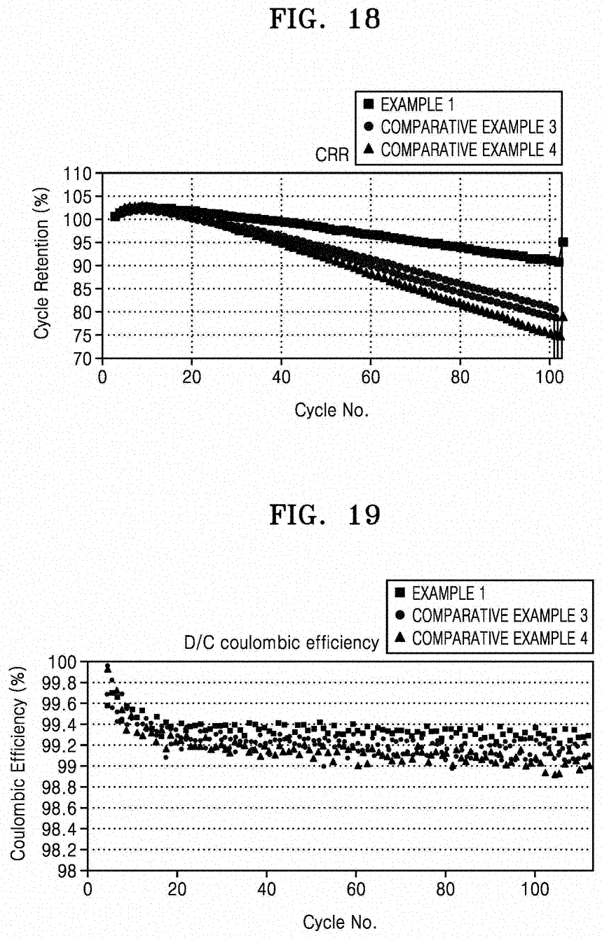

The measurements of the capacity retention ratio of the coin full cell manufactured according to each of Example 1 and Comparative Examples 3 and 4 are shown in FIG. 18, and the measurements of coulombic efficiency per cycle thereof are shown in FIG. 19.

In addition, the electrode density, current density, loading amount, initial efficiency, discharge capacity at 0.2 C, and capacity retention ratio in 100 cycles of the coin full cell manufactured according to Example 1 and Comparative Examples 3 and 4 are shown in Table 2.

TABLE 2

| | | | | | | CRR |
|---|---|---|---|---|---|---|
| | | | | | 0.2 C | (% |
| | Electrode | Current | | | Discharge | @100 |
| | density | density | L/L | ICE | Capacity | cycle, |
| Full Cell | (g/cc) | (mAh/cm²) | (mg/cm²) | (%) | (mAh/g) | 1 C) |
| Example 1 | 1.69 | 4.56 | 9.40 | 78.00 | 152.32 | 90.70 |
| Comparative | 1.76 | 4.42 | 9.11 | 78.08 | 151.71 | 78.32 |
| Example 1 | | | | | | |
| Comparative | 1.80 | 4.49 | 9.26 | 76.80 | 149.27 | 74.52 |
| Example 4 | | | | | | |

As illustrated in FIGS. 18 and 19 and shown in Table 2, the test results of the coin full cell showed that even when the same equivalent of lithium was used in the composite form, different cell-performances were obtained. In the case of the initial efficiency, the difference between Example 1 and Comparative Examples 3 and 4 was in as little as about 1%. However, in the case of lifespan characteristics, after 100 times of charge and discharge cycles, the difference in the capacity retention ratio was in the range of 10% to 15%. In the case that when Li-oxide was used as a precursor, the capacity retention ratio after 100 times of cycles was maintained at 90% or more.

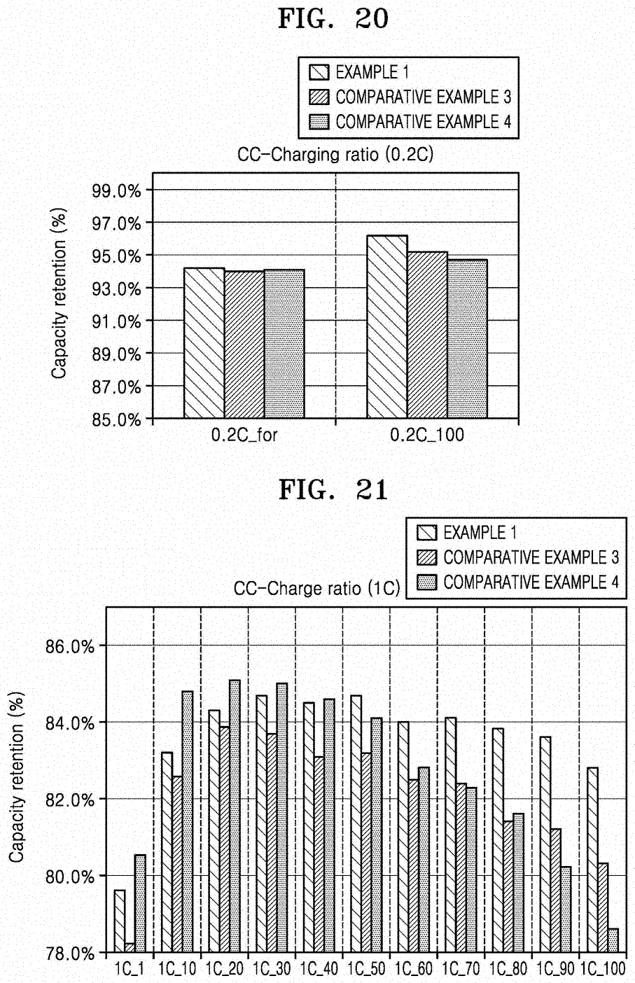

FIG. 20 shows evaluation results of rate characteristics of the coin full cells manufactured according to Example 1 and Comparative Examples 3 and 4 obtained by comparing the result of the constant current/constant voltage charging and the result of the constant-current charging, in the cycle at 0.2 C. FIG. 21 shows evaluation results of rate characteristics of the coin full cells manufactured according to Example 1 and Comparative Examples 3 and 4 obtained by comparing the result of the constant current/constant voltage charging and the result of the constant-current charging, in the cycle at 1 C.

As illustrated in FIGS. 20 and 21, it is confirmed that Example 1 in which Li-oxide was used for coating as a precursor showed remarkably improved rate characteristics than Comparative Examples 3 and 4 in which other precursors were used for coating.

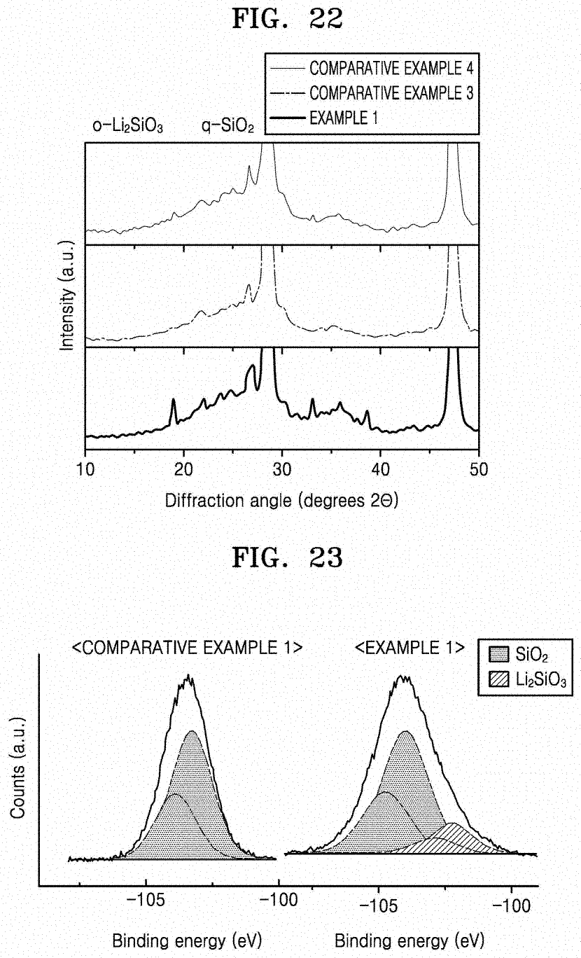

The XRD measurement results for analyzing the crystal structure of the coating layer of the negative active materials prepared according to Example 1 and Comparative Examples 3 and 4 are shown in FIG. 22.

As shown in FIG. 22, in the case of Example 1 using Li-oxide as a precursor, an orthorhombic crystal structure was clearly formed.

### Evaluation Example 5: Evaluation of X-Ray Photoelectron Spectroscopy (XPS)

To confirm surface-treatment effects after charging and discharging, with respect to the coin half cells of Comparative Example 1 and Example 1, an electrode was sampled after 100 cycles of charging and discharging, and a surface-product was confirmed by XPS analysis that shows binding energy information at about 10 nm away from the surface. The XPS analysis results of Comparative Example 1 and Example 1 are shown in FIG. 23.

As illustrated in FIG. 23, in Example 1, Li₂SiO₃ component remained stable even after 100 cycles. This shows that Example 1 improves lifespan characteristics by reducing irreversible lithium consumption and internal trapped lithium at the interface during charging and discharging, compared to Comparative Example 1.

A negative active material according to an embodiment includes a composite coating layer including a lithium-containing oxide having the orthorhombic crystal structure and a first carbonaceous material on an active material core. Due to the inclusion of the composite coating layer, the structural stability of the active material core is improved and the irreversible lithium consumption reaction on the surface of the active material core is suppressed, thereby leading to an increase in lifespan characteristics of a lithium secondary battery.

It should be understood that embodiments described herein should be considered in a descriptive sense only and not for purposes of limitation. Descriptions of features or aspects within each embodiment should be considered as available for other similar features or aspects in other embodiments.

While one or more embodiments have been described with reference to the figures, it will be understood by those of ordinary skill in the art that various changes in form and details may be made therein without departing from the spirit and scope as defined by the following claims.

What is claimed is:

1. A negative active material comprising:
an active material core; and
a composite coating layer on a surface of the active material core,
wherein the composite coating layer comprises
a lithium-containing oxide having an orthorhombic crystal structure, and
a first carbonaceous material.

2. The negative active material of claim 1, wherein
the lithium-containing oxide is represented by Formula 1:
LiₓM_{y}O_{z} Formula 1
wherein
M comprises Si, Al, Ti, Mn, Ni, Cu, V, Zr, Nb, or a combination thereof, and
0<x≤8, 0<y≤3, and 0<z≤(x+m·y)/2, where m is an oxidation number of M.

3. The negative active material of claim 2, wherein
the lithium-containing oxide comprises LiₓSi_{y}O_{z}, LiₓAl_{y}O_{z}, LiₓTi_{y}O_{z}, LiₓZr_{y}O_{z}, or a combination thereof, each having an orthorhombic crystal structure, wherein x, y, and z are the same as defined in Formula 1.

4. The negative active material of claim 1, wherein
the lithium-containing oxide comprises Li₂SiO₃ having an orthorhombic crystal structure.

5. The negative active material of claim 1, wherein
the first carbonaceous material comprises crystalline carbon, amorphous carbon, or a combination thereof.

6. The negative active material of claim 1, wherein
in the composite coating layer, the lithium-containing oxide is dispersed in the first carbonaceous material.

7. The negative active material of claim 1, wherein
the lithium-containing oxide is dispersed in the active material core.

8. The negative active material of claim 1, wherein
the composite coating layer further comprises a crystalline silicon oxide.

9. The negative active material of claim 1, wherein
an amount of the composite coating layer is in the range of about 0.01 part by weight to about 10 parts by weight, based on 100 parts by weight of the active material core.

10. The negative active material of claim 1, wherein
the active material core comprises a silicon-containing active material, a tin-containing active material, a silicon-tin alloy-containing active material, a silicon-carbon-containing active material, or a combination thereof.

11. The negative active material of claim 1, wherein
the active material core comprises Si, SiOₓ where 0≤x≤2, a Si—Z alloy where Z is an alkali metal, an alkaline earth metal, a Group 13 element, a Group 14 element, a Group 15 element, a Group 16 element, transition metal, a rare-earth element, or a combination thereof, and is not Si,
Sn, SnO₂, Sn—Z alloy where Z is an alkali metal, an alkaline earth metal, a Group 13 element, a Group 14 element, a Group 15 element, a Group 16 element, a transition metal, a rare-earth element, or a combination thereof, and is not Sn, or
a combination thereof.

12. The negative active material of claim 1, wherein
the active material core comprises a silicon secondary particle comprising of an agglomerate of silicon primary particles.

13. The negative active material of claim 1, wherein
the active material core comprises a silicon-carbon composite comprising a silicon-containing material and a second carbonaceous material.

14. The negative active material of claim 13, wherein
the silicon-containing material is in a form of a nanostructure, and the nanostructure comprises a nanoparticle, a nanowire, a nanorod, a nanofiber, a nanoporous body, a nanotemplate, an acicular body, or a combination thereof.

15. The negative active material of claim 13, wherein
the second carbonaceous material comprises a crystalline carbon, an amorphous carbon, or a combination thereof.

16. The negative active material of claim 1, wherein
the active material core comprises a porous silicon composite cluster comprising, a core and a shell,
wherein the core comprises a porous silicon composite secondary particle comprising an aggregate of two or more silicon composite primary particles,
wherein the silicon composite primary particles comprise silicon, a silicon oxide disposed on the silicon, and a first graphene disposed on the silicon oxide, and
wherein the shell comprises a second graphene disposed on the core.

17. The negative active material of claim 1, wherein
the active material core has a porous structure.

18. The negative active material of claim 1, wherein
the negative active material has a porosity which is greater than a porosity of a negative active material having a composite coating layer comprising a lithium-containing oxide which does not have the orthorhombic crystal structure.

19. The negative active material of claim 17, wherein
the composite coating layer is further disposed inside of the active material core having the porous structure.

20. The negative active material of claim 1, wherein
the negative active material has an average particle diameter of about 200 nanometers to about 50 micrometers, and a specific surface area of about 0.1 square meters per gram to about 15 square meters per gram.

21. A lithium secondary battery comprising:
a negative electrode comprising the negative active material of claim 1;
a positive electrode; and
an electrolyte between the negative electrode and the positive electrode.

22. A method of manufacturing a negative active material, the method comprising:
providing a mixture comprising an active material core and a coating precursor, wherein the coating precursor comprises a lithium precursor and a carbon precursor, and the lithium precursor is lithium oxide; and
heat-treating the mixture to form a composite coating layer on a surface of the active material core, wherein the composite coating layer comprises a lithium-containing oxide having an orthorhombic crystal structure and a first carbonaceous material.

23. The method of claim 22, wherein
the active material core comprises a silicon-containing active material, a tin-containing active material, a silicon-tin alloy-containing active material, a silicon-carbon-containing active material, or a combination thereof.

24. The method of claim 22, wherein
the carbon precursor comprises coal pitch, mesophase pitch, petroleum pitch, coal oil, petroleum heavy oil, organic synthetic pitch, a phenol resin, a furan resin, a polyimide resin, natural graphite, artificial graphite, expandable graphite, graphene, carbon nanotubes, or a combination thereof.

25. The method of claim 22, wherein the mixture further comprises
a metal precursor comprising Si, Al, Ti, Mn, Ni, Cu, V, Zr, Nb, or a combination thereof.

26. The method of claim 22, wherein
the heat-treating comprises heat-treating at a temperature of about 500° C. to about 1200° C.

27. The method of claim 22, wherein the mixture is prepared by dry-mixing the active material core and the coating precursor.

28. A negative active material comprising:
an active material core comprising a porous silicon-containing secondary particle; and
a composite coating layer on a surface of the active material core, wherein the composite coating layer comprises
a lithium silicon oxide having an orthorhombic crystal structure, and
a first carbonaceous material.
